(19) United States
(12) Patent Application Publication
(10) Pub. No.: US 2014/0001860 A1
(43) Pub. Date: Jan. 2, 2014

(54) FAST BUS TRANSFER METHOD AND DEVICE

(71) Applicants: Zhen Cao, Nanjing (CN); Xin Bo Gu, Nanjing (CN); Dieter Kramer, Dresden (DE); Qui Gun Miao, Nanjing (CN); Lei Ming Qin, Nanjing (CN)

(72) Inventors: Zhen Cao, Nanjing (CN); Xin Bo Gu, Nanjing (CN); Dieter Kramer, Dresden (DE); Qui Gun Miao, Nanjing (CN); Lei Ming Qin, Nanjing (CN)

(21) Appl. No.: 14/001,982

(22) PCT Filed: Feb. 28, 2012
(86) PCT No.: PCT/EP12/53329

§ 371 Date: Aug. 28, 2013

(30) Foreign Application Priority Data
Feb. 28, 2011 (CN) 2011-0047894.6

(51) Int. Cl. H02J 9/06

(52) U.S. Cl. CPC H02J 9/06
USPC 307/64

(57) ABSTRACT

A fast bus transfer method and a device reduce the impact on a load connected to a bus caused by a power cut. The method includes calculating the amplitude of the voltage vector difference between the bus and the backup power supply and the phase angle difference between the bus and the backup power supply; and transferring the load on the bus to the backup power supply only when the amplitude is less than its limit value and the phase angle difference is less than 90°. The device contains a detection module, a calculation module, a comparison module, and a transfer module. By calculating the real-time residual voltage, it is unnecessary for a user to know all the details of the residual voltage characteristic, and can achieve fast transfer simply by setting the limit of the voltage difference when a circuit breaker of the backup power supply is closed.

### TECHNICAL FIELD

The present invention relates to a fast bus transfer method, and especially, to a real-time fast transfer method. The present invention also relates to a fast bus transfer device, and especially, to a real-time fast transfer device.

### BACKGROUND ART

Fast bus transfer (FBT) can quickly transfer a bus connected to a load (for example, a motor) to a backup power supply when a main power supply fails, and its function is not only to maintain the continuous operation of the equipment, but also to avoid damage to the motor or other connected loads. Usually, such fast bus transfer is manually started, or in the case of failure, it is started by an external device, and its conventional transfer modes comprise three types: fast transfer, in-phase transfer, and residual voltage transfer. Each transfer mode is aimed at a particular situation, and the transfer modes each have their own criteria. Since fast transfer can theoretically keep the power interruption of the bus within the shortest time period and protect the motor or other loads from excessive or accumulated stress, fast transfer is usually preferred. If the criterion for fast transfer fails to be met, then the fast transfer equipment cannot send out a close command to the circuit breaker of the backup power supply, and the in-phase transfer mode will be subsequently started, that is, the inphase transfer mode serves as a backup solution to the fast transfer mode. Likewise, the residual voltage transfer mode serves as a backup solution to the in-phase transfer mode.

The criteria for these three different transfer modes are as follows:

1) Criteria for fast transfer: Δφ<Δφ_{FTparameter} and Δf<Δf_{FTparameter}.

Here, Δφ is the phase angle difference between the attenuated bus voltage and the backup power supply voltage, Δf is the frequency difference between the attenuated bus voltage and the backup power supply voltage, Δφ_{FTparameter} is a limit parameter of Δφ, Δf_{FTparameter} is a limit parameter of Δf, in which Δφ and Δf are real-time measurement values, while Δφ_{FTparameter} and Δf_{FTparameter} are instantaneous values when the circuit breaker of the main power supply opens and are determined by the user.

2) Criterion for in-phase transfer: Δφ_{forecast}<10°.

Here, Δφ_{forecast} is a forecast phase angle difference between the attenuated bus voltage and the voltage of the backup power supply, Δφ_{forecast} being a forecast value. If the fast transfer is missed, then the fast bus transfer device will automatically convert to the in-phase transfer. In-phase transfer is suitable for the situation where the phase angle difference is zero at the moment when the circuit breaker of the backup power supply is closed.

3) Criterion for residual voltage transfer: when the bus voltage drops to a predefined value, for example 30% of the rated value, then close the circuit breaker of the backup power supply.

This transfer is the slowest of all the transfer modes.

The criteria for the above various transfer modes are all restricted by the characteristics of the motor or other loads. The terminal voltage of the motor caused by the voltage difference across the circuit breaker should not exceed a permitted over-voltage value. It is usually 1.1 times the rated voltage Uₙ. FIG. 1 shows the characteristic an attenuated residual voltage, in which are illustratively shown a fast transfer section 30, an in-phase transfer section 20 and the voltage U_{A} of the backup power supply. Supposing that the voltage difference is 1.0 Uₙ, on the right side of the curve A′-A″ is a safe area for re-supply. When the voltage difference is lower than 1.0 Uₙ, a new voltage level will form a new safe area, i.e., the right side of B′-B″.

Since the premise for determining parameters is to comprehensively analyze the residual voltage characteristic, it is hard for the user to use fast transfer mode correctly. When the motor disconnects the electrical connection with the power supply, the energy stored in the magnetic field of the motor will generate an induced voltage which is referred to as residual voltage. The amplitude and frequency of this induced voltage will attenuate, the attenuation trend and attenuation rate depending upon a variety of factors, such as the type of motor, the load of the motor, the inertia of the motor and so on. Therefore, it is difficult for the user to determine the values for the parameters Δφ_{FTparameter} and Δf_{FTparameter} properly. At the same time, theoretically, the residual voltage characteristic will change if any one of the factors varies, therefore Δφ_{FTparameter} and Δf_{FTparameter} will also need to be redetermined accordingly, however, it is quite difficult. In view of this, the user usually determines relatively small values for Δφ_{FTparameter} and Δf_{FTparameter}, so as to avoid the fast bus transfer exceeding its application range, with the result that the fast bus transfer cannot function adequately, thereby losing the best occasion for re-supplying the motor connected to the bus and maintaining operation continuity, while waiting for in-phase transfer to respond takes a time period of several hundreds of milliseconds. This delay will prolong the transfer time, and increase the impact current and impact moment.

### Contents of the Invention

The object of the present invention is to provide a fast bus transfer method to reduce, by transferring between a main power supply and a backup power supply, the impact on a load connected to a bus due to a power cut. The method comprises: 1) calculating the amplitude ΔU_{forecast} of the voltage vector difference between the bus and the backup power supply and calculating the phase angle difference Δφ_{forecast} between the bus and the backup power supply; 2) transferring the load on the bus to said backup power supply only when ΔU_{forecast} is less than its limit value ΔU_{RTFTparameter} and Δφ_{forecast} is less than 90°.

According to one aspect of the present invention, both ΔU_{forecast} and Δφ_{forecast} are forecast values at the moment when the circuit breaker of said backup power supply is closed.

According to another aspect of the present invention, ΔU_{forecast} is obtained by calculation according to the following formula:

$$Δ {U}_{forecast} = \sqrt{{U}_{Mforecast}^{2} + {U}_{A}^{2} - 2 * {U}_{Mforecast} * {U}_{A} * cos Δ {ϕ}_{forecast}} ,$$

in which U_{Mforecast} is a forecast value of a motor's residual voltage, and U_{A} is the voltage of the backup power supply.

According to yet another aspect of the present invention U_{Mforecast} is obtained by calculation according to the following formula:

U_{Mforecast}=Uₜ_{₂}(1+λ*Δt+½*(λ*Δt)²),

in which Uₜ_{₂} is the real-time amplitude at the moment t₂; Δt is the time difference between the moment t₂ and the moment t₁, that is, the time period for the circuit breaker to close; and

$$λ = - \frac{1}{τ} ,$$

τ being a time constant.

According to yet another aspect of the present invention, Δφ_{forecast} is obtained by calculation according to the following formula:

Δφ_{forecast}=Δφₜ_{₂}+Δωₜ_{₂}*Δt+½*α*Δt^{2,}

in which Δφₜ_{₂} is the phase difference at the moment t₂, Δωₜ_{₂} is the angular velocity difference at the moment t₂, and α is the attenuation rate of an angular velocity defined according to a residual voltage transfer mode, and Δt is the time difference between the moment t₂ and the moment t₁, that is, the time period for the circuit breaker to close.

According to yet another aspect of the present invention, λ is obtained by calculation according to the following formula:

$$λ = \frac{1 - \sqrt{\frac{2 * {U}_{{t}_{1}}}{{U}_{{t}_{2}}} - 1}}{{t}_{2} - {t}_{1}} ,$$

in which Uₜ_{₁} is the real-time amplitude at the moment t₁.

According to yet another aspect of the present invention, Δωₜ_{₂} and α are obtained by calculation according to the following formulae respectively:

$${Δω}_{{t}_{2}} = \frac{Δ {ϕ}_{{t}_{2}} - Δ {ϕ}_{{t}_{1}}}{{t}_{2} - {t}_{1}} , and α = \frac{Δ {ω}_{{t}_{2}} - Δ {ω}_{{t}_{1}}}{{t}_{2} - {t}_{1}} ,$$

in which Δωₜ_{₁} is the angular velocity difference at the moment t₁, and Δωₜ_{₁} is the phase difference at the moment t₁.

The object of the present invention is to further provide a fast bus transfer device to reduce, by transferring between a main power supply and a backup power supply, the impact on a load connected to a bus due to a power cut. The device comprises: a detection module, for detecting signals at the main power supply, the backup power supply and the bus; a calculation module, for receiving said signals, and calculating the amplitude ΔU_{forecast} of the voltage vector difference between the bus and the backup power supply and calculating the phase angle difference Δφ_{forecast} between the bus and the backup power supply; a comparison module, for receiving ΔU_{forecast} and Δφ_{forecast}, comparing Δφ_{forecast} with its limit value ΔU_{RTFTparameter}, and comparing Δφ_{forecast} with 90°; and a transfer module, for receiving the comparison results from the comparison module, and transferring the load on the bus to said backup power supply only when ΔU_{forecast} is less than its limit value ΔU_{RTFTparameter} and Δφ_{forecast} is less than 90°.

According to one aspect of the present invention, said calculation module obtains ΔU_{forecast} by calculation according to the following formula:

$$Δ {U}_{forecast} = {\overline{√ {U}_{Mforecast}^{2} + {U}_{A}^{2} - 2 * {U}_{Mforecast} * {U}_{A} * cos Δ ϕ}}_{forecast}$$

in which U_{Mforecast} is a forecast value of a motor's residual voltage, and U_{A} is the voltage of the backup power supply.

According to another aspect of the present invention, said calculation module obtains U_{Mforecast} by calculation according to the following formula:

U_{Mforecast}=Uₜ_{₂}(1+λ*Δt+½*(λ*Δt)²),

in which Uₜ_{₂} is the real-time amplitude at the moment t₂; Δt is the time difference between the moment t₂ and the moment t₁, that is, the time period for the circuit breaker to close; and

$$λ = - \frac{1}{τ} ,$$

τ being a time constant.

According to yet another aspect of the present invention, said calculation module obtains Δφ_{forecast} by calculation according to the following formula:

Δ_{forecast}=Δφₜ_{₂}+Δωₜ_{₂}*Δt+½*α*Δt²,

in which Δφₜ_{₂} is the phase difference at the moment t₂, Δωₜ_{₂} is the angular velocity difference at the moment t₂, Δt is the time difference between the moment t₂ and the moment t₁, that is, the time period for the circuit breaker to close, and α is the attenuation rate of an angular velocity defined according to a residual voltage transfer mode.

According to yet another aspect of the present invention, said calculation module obtains λ by calculation according to the following formula:

$$λ = \frac{1 - \sqrt{\frac{2 * {U}_{{t}_{1}}}{{U}_{{t}_{2}}} - 1}}{{t}_{2} - {t}_{1}} ,$$

in which Uₜ_{₁} is the real-time amplitude at the moment t₁.

According to yet another aspect of the present invention, Δωₜ_{₂} and α are obtained by calculation by said calculation module according to the following formulae:

$${Δω}_{{t}_{2}} = \frac{Δ {ϕ}_{{t}_{2}} - Δ {ϕ}_{{t}_{1}}}{{t}_{2} - {t}_{1}} , and α = \frac{Δ {ω}_{{t}_{2}} - Δ {ω}_{{t}_{1}}}{{t}_{2} - {t}_{1}} ,$$

in which Δωₜ_{₁} is the angular velocity difference at the moment t₁, and Δφₜ_{₁} is the phase difference at the moment t₁.

The advantages of the present invention lie in the following: by way of calculating a real-time residual voltage, it is unnecessary for the user to be well-acquainted with the residual voltage characteristic; he only needs to set the limit of the voltage difference at the moment when the circuit breaker of the backup power supply is closed, and fast transfer can then be easily achieved; moreover, it is unnecessary to adjust previous settings in response to variation of the residual voltage characteristic, thereby making it extremely convenient for the user to operate, and overcoming the imperfections in the prior art.

### BRIEF DESCRIPTION OF THE ACCOMPANYING DRAWINGS

The features and advantages of the present invention will become clearer in combination with the following accompanying drawings, in which identical symbols represent identical components or means:

FIG. 1 illustratively shows the characteristic of an attenuated residual voltage in the prior art;

FIG. 2 illustratively shows a system in which the method and device according to the present invention are used;

FIG. 3 illustratively shows a vector relationship among the amplitude ΔU_{forecast} of the voltage vector difference between the bus and the backup power supply, the phase angle difference Δφ_{forecast} between the bus and the backup power supply, the forecast value U_{Mforecast} of a motor's residual voltage, and the voltage U_{A} of the backup power supply; and

FIG. 4 illustratively shows the characteristic of an attenuated residual voltage in the present invention.

### EXEMPLARY EMBODIMENTS

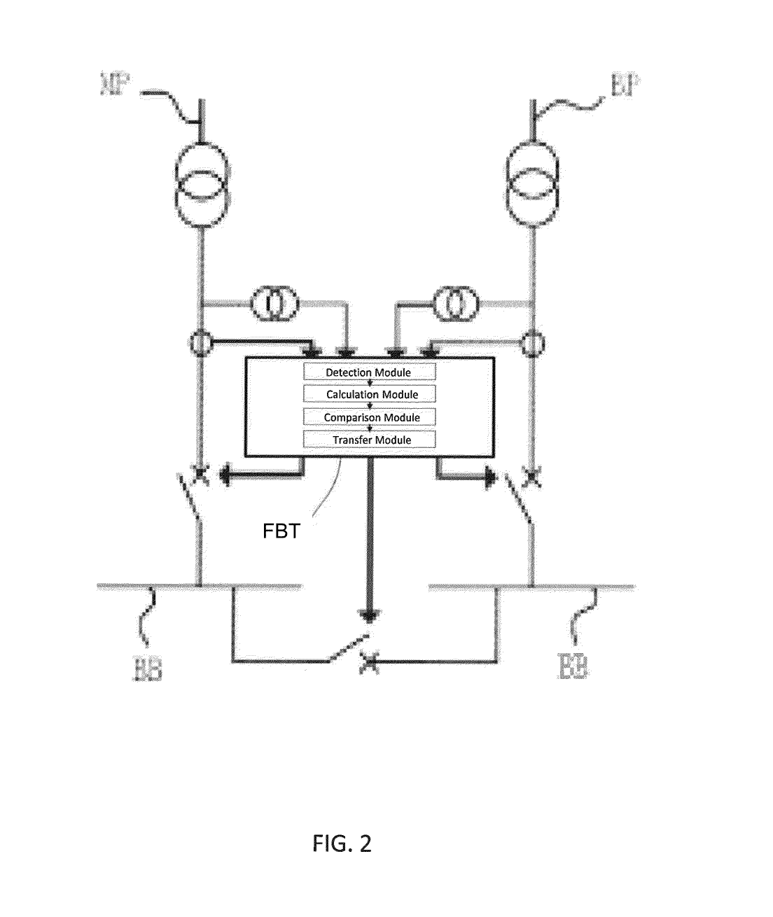

FIG. 2 illustratively shows a system in which the method and/or device according to the present invention are used, in which the buses BB are electrically connected to each other during normal operation and can be connected to other loads such as a motor. A main power supply MP and a backup power supply BP can be respectively connected to the buses BB through a fast bus transfer device FBT.

The fast bus transfer method according to the present invention reduces the impact on the load connected to the buses BB (such as an electric motor) due to a power cut by transferring between the main power supply MP and the backup power supply BP, and comprises two steps:

1) calculating the amplitude ΔU_{forecast} of the voltage vector difference between the bus BB and the backup power supply BP and calculating the phase angle difference Δφ_{forecast} between the bus BB and the backup power supply BP;

2) transferring the load on the bus to the backup power supply BP only when ΔU_{forecast} is less than its limit value ΔU_{RTFTparameter} and Δφ_{forecast} is less than 90°.

In this case, ΔU_{forecast} and Δφ_{forecast} are forecast values at the moment when the circuit breaker of the backup power supply BP is closed, while ΔU_{RTFTparameter} and 90° are permitted values at the moment when the circuit breaker of the backup power supply BP is closed.

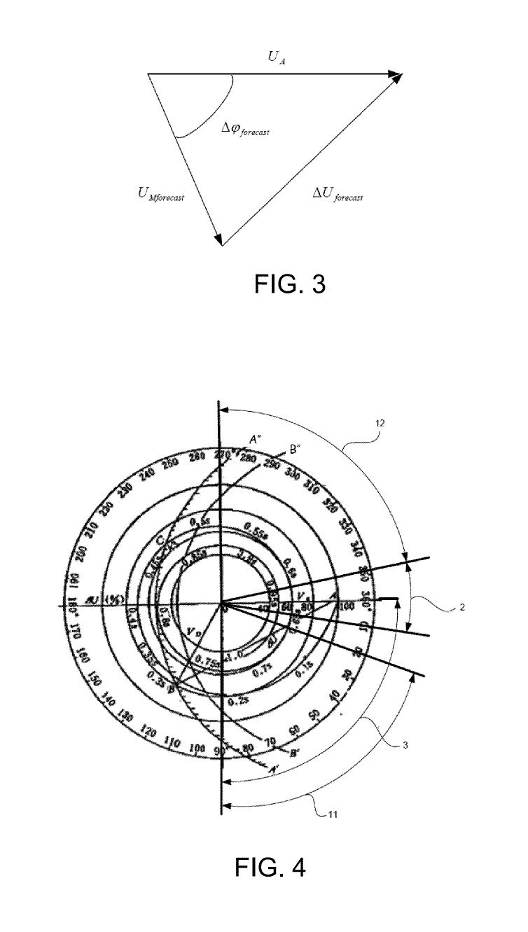

FIG. 3 illustratively shows a vector relationship among the amplitude ΔU_{forecast} of the voltage vector difference, the phase angle difference Δφ_{forecast}, the forecast value U_{Mforecast} of the motor's residual voltage, and the voltage U_{A} of the backup power supply. The voltage difference depends upon the angle difference between the residual voltage of the bus and the voltage of the backup power supply. ΔU_{forecast} is obtained by calculation according to the following formula (1):

$$Δ {U}_{forecast} = \sqrt{{U}_{Mforecast}^{2} + {U}_{A}^{2} - 2 * {U}_{Mforecast} * {U}_{A} * cos Δ {ϕ}_{forecast}} ,$$

in which U_{Mforecast} is a forecast value of the motor's residual voltage at the moment when the circuit breaker of the backup power supply BP is closed, and U_{A} is the voltage of the backup power supply.

It can be known from the residual voltage characteristic formula

$$U ( t ) = {U}_{0} * {e}^{- \frac{t}{τ}} sin ( ( {ω}_{0} - α * t ) * t + {ϕ}_{0} )$$

that the real-time amplitude of the residual voltage at a certain moment is

$${U}_{t} = {U}_{0} * {e}^{- \frac{t}{τ}} ,$$

in which U₀ is the initial amplitude of the residual voltage, τ is a time constant of the attenuated residual voltage, ω₀ is the initial angular velocity of the residual voltage, φ₀ is the initial phase of the residual voltage, and α is the attenuation rate of the angular velocity. In view of the fact that both U₀ and e are constants, the amplitude Uₜ at any moment t can be obtained by calculation as long as the value of the time constant τ is known. This can be achieved using the following algorithm, for example, if the amplitude at the moment t₁ is

$${U}_{{t}_{1}} = {U}_{0} * {e}^{- \frac{{t}_{1}}{τ}}$$

and the amplitude at the moment t₂ is

$${U}_{{t}_{2}} = {U}_{0} * {e}^{- \frac{{t}_{2}}{τ}} ,$$

then

$$\frac{{U}_{{t}_{1}}}{{U}_{{t}_{2}}} = {e}^{- \frac{{t}_{1} - {t}_{2}}{τ}}$$

is obtained, and this is expanded using Taylor's formula to:

$$\frac{{U}_{{t}_{1}}}{{U}_{{t}_{2}}} = 1 - \frac{{t}_{1} - {t}_{2}}{τ} + \frac{1}{2} * {( \frac{{t}_{1} - {t}_{2}}{τ} )}^{2} ;$$

let

$$λ = - \frac{1}{τ} , \frac{{( {t}_{1} - {t}_{2} )}^{2}}{2} * {λ}^{2} + ( {t}_{1} - {t}_{2} ) * λ + ( 1 - \frac{{U}_{{t}_{1}}}{{U}_{{t}_{2}}} ) = 0$$

is thus obtained, and

$$λ = \frac{1 - \sqrt{\frac{2 * {U}_{{t}_{1}}}{{U}_{{t}_{2}}} - 1}}{{t}_{2} - {t}_{1}}$$

can be obtained, and the value of the time constant τ can be obtained by calculation through λ. Suppose that the time consumed by the closing of the circuit breaker is Δt, then the predicted residual voltage of the motor is

$$\begin{matrix}{U}_{Mforcast} = {U}_{0} {e}^{- \frac{{t}_{connection}}{τ}} \\ = {U}_{0} {e}^{- \frac{{t}_{2} + Δ t}{τ}} \\ = {U}_{0} {e}^{- \frac{{t}_{2}}{τ}} * {e}^{- \frac{Δ t}{τ}} \\ = {U}_{{t}_{2}} {e}^{- \frac{Δ t}{τ}} ,\end{matrix}$$

and the formula (2) U_{Mforecast}=Uₜ_{₂}(1+λ*Δt+½*(λ*Δt)²) is obtained by expanding using Taylor's formula.

In the residual mode which is already defined, the frequency attenuates linearly, therefore the following formula (3) can be used to predict the phase difference at the connecting moment, Δφ_{forecast} is obtained by calculation according to the following formula: Δφ_{forecast}=Δφₜ_{₂}+Δωₜ_{₂}*Δt+½*α*Δt², in which

$${Δω}_{{t}_{2}} = \frac{{Δϕ}_{{t}_{2}} - {Δϕ}_{{t}_{1}}}{{t}_{2} - {t}_{1}} , \\ α = \frac{{Δω}_{{t}_{2}} - {Δω}_{{t}_{1}}}{{t}_{2} - {t}_{1}} ,$$

Δωₜ_{₂} is the angular velocity difference at the moment t₂, Δω^{t}_{₁} is the angular velocity difference at the moment t₁, Δφₜ_{₂} is the phase difference at the moment t₂, Δφₜ_{₁} is the phase difference at the moment t₁, α is the attenuation rate of an angular velocity defined according to the residual transfer mode, Δt is the time difference between the moment t₂ and the moment t₁, that is, the time period for the circuit breaker to close. By substituting the above formulae (2) and (3) into formula (1), the amplitude ΔU_{forecast} of the voltage vector difference can be obtained.

According to another embodiment of the present invention, a fast bus transfer device comprises: a detection module, for detecting signals at the main power supply, the backup power supply and the bus; a calculation module, for receiving said signals, and calculating the amplitude ΔU_{forecast} of the voltage vector difference between the bus and the backup power supply and calculating the phase angle difference Δφ_{forecast} between the bus and the backup power supply; a comparison module, for receiving ΔU_{forecast} and Δφ_{forecast}, comparing Δφ_{forecast} with its limit value ΔU_{RTFTparameter}, and comparing Δφ_{forecast} with 90°; and a transfer module, for receiving the comparison results from the comparison module, and transferring the load on the bus to said backup power supply only when ΔU_{forecast} is less than its limit value ΔU_{RTFTparameter} and Δφ_{forecast} is less than 90°.

The signals detected by the detection module are various physical quantities that can be obtained without calculation in the present invention, and these physical quantities can be used as the basis for further calculation carried out using various formulae in the present invention and are sent to the calculation module.

Said calculation module obtains ΔU_{forecast} by calculation according to the following formula:

$$Δ {U}_{forecast} = \sqrt{{U}_{Mforecast}^{2} + {U}_{A}^{2} - 2 * {U}_{Mforecast} * {U}_{A} * cos {Δϕ}_{forecast}} ,$$

in which U_{Mforecast} is a forecast value of the motor's residual voltage, and U_{A} is the voltage of the backup power supply.

Said calculation module obtains U_{Mforecast} by calculation according to the following formula:

U_{Mforecast}=Uₜ_{₂}(1+λ*Δt+½I(λ*Δt)²),

in which Uₜ_{₂} is the real-time amplitude at the moment t₂; Δt is the time difference between the moment t₂ and the moment t₁, that is, the time period for the circuit breaker to close; and

$$λ = - \frac{1}{τ} ,$$

τ being a time constant

Said calculation module obtains Δφ_{forecast} by calculation according to the following formula:

Δφ_{forecast}=Δφₜ_{₂}Δωₜ_{₂}*Δt+½*α*Δt²,

in which Δφₜ_{₂} is the phase difference at the moment t₂, Δωₜ_{₂} is the angular velocity difference at the moment t₂, Δt is the time difference between the moment t₂ and the moment t₁, that is, the time period for the circuit breaker to close, and α is the attenuation rate of an angular velocity defined according to the residual voltage transfer mode.

Said calculation module obtains λ by calculation according to the following formula:

$$λ = \frac{1 - \sqrt{\frac{2 * {U}_{{t}_{1}}}{{U}_{{t}_{2}}} - 1}}{{t}_{2} - {t}_{1}} ,$$

in which Uₜ_{₁} is the real-time amplitude at the moment t₁.

Said calculation module obtains Δωₜ_{₂} and α by calculation according to the following formulae:

$${Δω}_{{t}_{2}} = \frac{{Δϕ}_{{t}_{2}} - {Δϕ}_{{t}_{1}}}{{t}_{2} - {t}_{1}}$$

$$and$$

$$α = \frac{{Δω}_{{t}_{2}} - {Δω}_{{t}_{1}}}{{t}_{2} - {t}_{1}} ,$$

in which Δωₜ_{₁} is the angular velocity difference at the moment t₁, and Δφₜ_{₁} is the phase difference at the moment t₁.

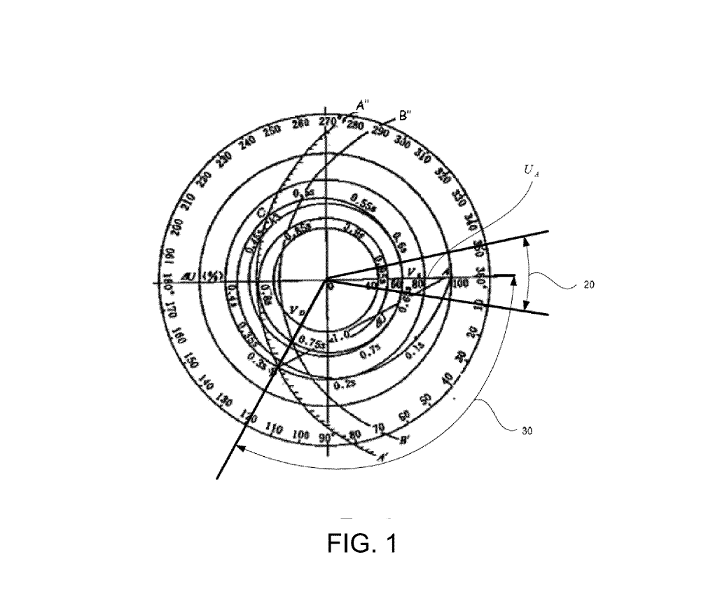

FIG. 4 illustratively shows the characteristic of an attenuated residual voltage in the present invention. As compared with the prior art shown in FIG. 1, the present invention has a real-time fast transfer section which is composed of two parts: a real-time fast transfer section 11 and a real-time fast transfer section 12, as well as an in-phase transfer section 2. The real-time fast transfer section in the present invention is not only greater than the fast transfer section 30 shown in FIG. 1, but also greater than the fast transfer section 3 shown in FIG. 4. The method and device according to the present invention can utilize the safe area for re-supply more fully, thereby achieving better technical effects.

Although embodiments of the present invention are illustrated above, the described embodiments are not intended to exhibit all possible forms of the present invention. In addition, the contents of the description are illustrative rather than restrictive. All kinds of variations and modifications can be made to the contents of the description by those skilled in the art without departing from the spirit of the present invention and the scope of the claims.

1-13. (canceled)

14. A fast bus transfer method for reducing an impact on a load connected to a bus caused by a power cut by transferring between a main power supply and a backup power supply, which comprises the steps of:
calculating an amplitude ΔU_{forecast} of a voltage vector difference between the bus and the backup power supply;
calculating a phase angle difference ΔU_{forecast} between the bus and the backup power supply; and
transferring the load on the bus to the backup power supply only when the amplitude ΔU_{forecast} is less than a limit value ΔU_{RTFTparameter} and the phase angle difference Δφ_{forecast} is less than 90°.

15. The method according to claim 14, wherein both the amplitude ΔU_{forecast} and the phase angle difference Δφ_{forecast} are forecast values at a time when a circuit breaker of the backup power supply is closed.

16. The method according to claim 14, wherein the amplitude ΔU_{forecast} is obtained by calculation according to the following formula:
$$Δ {U}_{forecast} = \sqrt{{U}_{Mforecast}^{2} + {U}_{A}^{2} - 2 * {U}_{Mforecast} * {U}_{A} * cos {Δϕ}_{forecast}} ,$$
in which U_{Mforecast is} a forecast value of a residual voltage; and
U_{A} is a voltage of the backup power supply.

17. The method according to claim 16, which further comprises:
obtaining the forecast value U_{Mforecast} by calculation according to the following formula:
U_{Mforecast}=Uₜ_{₂}(1+λ*Δt+½*(λ*Δt)²),
in which Uₜ_{₂} is a real-time amplitude at moment t₂;
Δt is a time difference between the moment t₂ and moment t₁, that is a time period for a circuit breaker to close; and
$$λ = - \frac{1}{τ} ,$$
τ being a time constant.

18. The method according to claim 16, which further comprises:
obtaining the phase angle difference Δφ_{forecast} by calculation according to the following formula:
Δφ_{forecast}=Δφₜ_{₂}+Δωₜ_{₂}*Δt+½*α*Δt²,
in which Δφₜ_{₂} is a phase difference at moment t₂;
Δωₜ_{₂} is an angular velocity difference at the moment t₂;
α is an attenuation rate of an angular velocity defined according to a residual voltage transfer mode; and
Δt is a time difference between the moment t₂ and the moment t₁, that is, a time period for a circuit breaker to close.

19. The method according to claim 17, which further comprises:
obtaining the λ by calculation according to the following formula:
$$λ = \frac{\sqrt[1 -]{\frac{2 * {U}_{{t}_{1}}}{{U}_{{t}_{2}}} - 1}}{{t}_{2} - {t}_{1}} ,$$
in which Uₜ_{₁} is a real-time amplitude at the moment t₁.

20. The method according to claim 18, wherein the angular velocity difference Δωₜ_{₂} and the attenuation rate a are obtained respectively by calculation according to the following formulae:
$${Δω}_{{t}_{2}} = \frac{{Δϕ}_{{t}_{2} -} {Δϕ}_{{t}_{1}}}{{t}_{2} - {t}_{1}} , \\ and$$
$$α = \frac{{Δω}_{{t}_{2} -} {Δω}_{{t}_{1}}}{{t}_{2} - {t}_{1}} ,$$
in which Δωₜ_{₁} is an angular velocity difference at the moment t₁, and
Δφₜ_{₁} is a phase difference at the moment t₁.

21. A fast bus transfer device for reducing an impact on a load connected to a bus caused by a power cut by transferring between a main power supply and a backup power supply, the fast bus transfer device comprising:
a detection module for detecting signals at the main power supply, the backup power supply and the bus;
a calculation module for receiving the signals, and calculating an amplitude ΔU_{forecast} of a voltage vector difference between the bus and the backup power supply and a phase angle difference Δφ_{forecast} between the bus and the backup power supply;
a comparison module for receiving the amplitude ΔU_{forecast} and the phase angle difference Δφ_{forecast}, comparing the amplitude Δφ_{forecast} with a limit value ΔU_{RTFTparameter}, and comparing the phase angle difference Δφ_{forecast} with 90°; and
a transfer module for receiving comparison results from said comparison module, and to transfer the load on the bus to the backup power supply only when the amplitude ΔU_{forecast} is less than the limit value ΔU_{RTFTparameter} and the phase angle difference ΔU_{forecast} is less than 90°.

22. The device according to claim 21, wherein said calculation module obtains the amplitude ΔU_{forecast} by calculation according to the following formula:
$$Δ {U}_{forecast} = \sqrt{{U}_{Mforecast}^{2} + {U}_{A}^{2} - 2 * {U}_{Mforecast} * {U}_{A} * cos {Δϕ}_{forecast}} ,$$
in which U_{Mforecast} is a forecast value of a residual voltage, and
U_{A} is a voltage of the backup power supply.

23. The device according to claim 22, wherein said calculation module obtains the forecast value U_{Mforecast} by calculation according to the following formula:
U_{Mforecast}=Uₜ_{₂}(1+λ*Δt+½*(λ*Δt)²),
in which Uₜ_{₂} is a real-time amplitude at moment t₂;
Δt is a time difference between the moment t₂ and moment t₁, that is, a time period for a circuit breaker to close; and
$$λ = - \frac{1}{τ} ,$$
τ being a time constant.

24. The device according to claim 22, wherein said calculation module obtains the phase angle difference Δφ_{forecast} by calculation according to the following formula:
Δφ_{forecast}=Δφₜ_{₂}Δωₜ_{₂}*Δt+½*α*Δt²
in which Δφₜ_{₂} is a phase difference at a moment t₂;
Δωₜ_{₂} is an angular velocity difference at the moment t₂;
Δt is a time difference between the moment t₂ and a moment t₁, that is, a time period for a circuit breaker to close; and
α is an attenuation rate of an angular velocity defined according to a residual voltage transfer mode.

25. The device according to claim 23, wherein said calculation module obtains the λ by calculation according to the following formula:
$$= \frac{\sqrt[1 -]{\frac{2 * {U}_{{t}_{1}}}{{U}_{{t}_{2}}} - 1}}{{t}_{2} - {t}_{1}}$$
in which Uₜ_{₁}is a real-time amplitude at the moment t₁.

26. The device according to claim 24, wherein said calculation module obtains the angular velocity difference Δωₜ_{₂} and the attenuation rate α by calculation according to the following formulae:
$${Δω}_{{t}_{2}} = \frac{{Δϕ}_{{t}_{2}} - {Δϕ}_{{t}_{1}}}{{t}_{2} - {t}_{1}} , \\ and$$
$$α = \frac{{Δω}_{{t}_{2} -} {Δω}_{{t}_{1}}}{{t}_{2} - {t}_{1}} ,$$
in which Δωₜ_{₁} is an angular velocity difference at the moment t₁, and
Δωₜ_{₁} is a phase difference at the moment t₁.
